(19) United States
(12) Patent Application Publication
(10) Pub. No.: US 2010/0012581 A1
(43) Pub. Date: Jan. 21, 2010

(54) DENITRIFICATION TREATMENT SYSTEM AND METHOD

(75) Inventors: Alon Singer, Kfar Vradim (IL); Shmuel Parnes, Beer-Sheva (IL); Asher Brener, Omer (IL); Amir Sagi, Omer (IL)

Correspondence Address: NIXON & VANDERHYE, PC, 901 NORTH GLEBE ROAD, 11TH FLOOR, ARLINGTON, VA, 22203, US

(73) Assignee: BEN-GURION UNIVERSITY OF THE NEGEV RESEARCH AND DEVELOPMENT AUTHORITY, Beer-Sheva (IL)

(21) Appl. No.: 12/227,863

(22) PCT Filed: May 31, 2007
(86) PCT No.: PCT/IL2007/000670

§ 371 Date: Mar. 9, 2009

Related U.S. Application Data
(60) Provisional application No. 60/809,832, filed on Jun. 1, 2006.

(51) Int. Cl. C02F 3/28

(52) U.S. Cl. 210/610; 210/188

(57) ABSTRACT

A two-stage treatment process, for the treatment of nitrate rich water, particularly aquaculture pond water, wherein in the first stage a degassing chamber is used for removing dissolved oxygen from a stream of water flowing out of the aquaculture system, and in the second stage the stream of water obtained from said degassing chamber is flown into a denitrifying biofilter comprising a biofilter media which functions as a biological growth media and as a carbon source, wherein said denitrifying biofilter is capable of biologically reducing both nitrate and nitrite compounds into nitrogen gas.

### FIELD OF THE INVENTION

The present invention generally relates to an apparatus and method for treating water, and in particular, to an apparatus and method for the denitrification of wastewater.

### BACKGROUND OF THE INVENTION

The present invention aims to provide a compact water treatment system for the removal of nitrate (and nitrite), which is particularly useful for aquaculture (aquafarming) systems including, but not limited to, small, remote and urban systems.

Maintaining acceptable water quality is without doubt the bottleneck in recirculating aquaculture systems (vanRijn, J. The potential for integrated biological treatment systems in urecirculating fish culture—A review, Aquaculture, 1996, Vol. 139, pp. 181-201). The most common problems in such systems are the accumulation of inorganic Nitrogen compounds, particularly Ammonia, Nitrite and Nitrate. In order to curb these effects, biological treatment systems are usually used. Nitrification, where Ammonia is oxidized to Nitrate through Nitrite is known by:

55NH₄⁺+76O₂+109HCO₃⁻ [symbol] C₅H₇O₂N+54NO₂⁻+57H₂O+104H₂CO₃ 1.

400NO₂⁻+NH₄⁺+4H₂CO₃+HCO₃⁻+195O₂ [symbol] C₅H₇O₂N+3H₂O+400NO₃⁻ 2.

A popular and economically feasible method to remove ammonia/ammonium, by nitrification, is through the use of trickling filters. The importance of bed substrate in nitrifying biofilters is immense (Kim, S. K. et al., Removal of ammonium-N from a recirculating aquaculture system using an immobilized nitrifier, Aquacultural Engineering, 2000, Vol. 21, pp. 139-150). If efficient nitrification is to take place, the bed substrate needs to be porous, durable, and low in cost, have a high surface area to volume ratio, not to clog easily, and to supports a homogenous flow of water.

Denitrification, the process wherein Nitrate is reduced to Nitrogen gas (also through nitrite), is defined by:

1000NO₃⁻+880CH₃COO⁻+H⁺ [symbol] 88C₅H₇O₂N+460N₂+420CO₂+880HCO₃⁻+1070H₂O 3.

The process of biological denitrification is carried out by facultative anaerobic bacteria, which in the presence of a carbon source, and in the absence of dissolved gaseous oxygen carry out the process. Furthermore, denitrification serves to increase the buffering capacity of the system (vanRijn, 1996). Additionally, providing an anaerobic environment not only serves to remove Nitrate, but can also reduce the total system phosphate concentrations (Barak, Y., vanRijn, J., Biological phosphate removal in a prototype recirculating aquaculture treatment system, Aquacultural Engineering, 2000, Vol. 22, pp. 121-136), and be applied for the removal of various contaminants present in water and wastewater.

Environmentally friendly recirculation systems, which conform to strict environmental legislation, are acknowledged as a needed, feasible approach, both technically and economically, for inland aquaculture. The water quality parameters of greatest relevance are Ammonia, Nitrite and Nitrate concentrations, and accordingly, improved designs and technologies to perform nitrification as well as denitrification, have been researched intensively. However, research into systems having to do specifically with biological nitrate reduction by process of denitrification, in systems used for aquaculture, are lagging behind. Those designs that have been suggested, though relatively effective, are large and cumbersome, difficult to maintain, and therefore expensive. The two major problems characterizing the existing denitrification systems used nowadays are: i) the addition of the correct amounts of soluble carbon compounds (such as methanol) to support bacterial growth is difficult to maintain (due to fluctuations of water flow rate and nitrate levels) and therefore, might leach and contaminate the system water; and ii) high levels of oxygen in the biofilter inflow (close to saturation due to intensive aeration of the ponds) inhibit denitrification and cause partial aerobic degradation of the organic carbon applied. Thus, these denitrification systems require larger systems in order to compensate lose of organic matter in aerobic metabolism.

It is well known that the existence of inorganic soluble Nitrogen compounds is one of the by products of the aquaculture industry. In general, to remedy this, a biological treatment has been implemented. However, the biological treatment comprises two processes, i.e. a nitrification process for converting Ammonia to Nitrate, and a denitrification process for converting Nitrate to Nitrogen gas. This biological treatment is the source of some difficulties which are due to the fact that the two different reaction vessels needed (i.e., nitrification and denitrification) require different physical conditions. Moreover, additional difficulties to be resolved in these systems are due to the negative influence (reduction in growth) the residual concentrations of dissolved oxygen in system water (following aeration in the aquaculture ponds where oxygen reaches saturation) has on the denitrifying bacteria.

The currently known denitrifying systems require an external source of carbon. This source is usually chosen to be a simple and cheap soluble material such as methanol, ethanol or glucose (Sauthier et al., Biological denitrification applied to a marine closed aquaculture system, Water Research, 1998, Vol. 32, pp. 1932-1938). Anason et al (Limited water exchange production systems for ornamental fish, Aquaculture Research, 2003, Vol. 34, pp. 937-941) made a rudimentary attempt to see if building a recirculating system is possible using only the most minimal of capital investments. This study showed that by providing even the most basic of biological filters, it becomes possible to decrease the amount of water needed in order to deal with inorganic nitrogen accumulation.

One experiment (Menasveta, P. at al., Design and function of a closed, recirculating seawater system with denitrification for the culture of black tiger shrimp broodstock, Aquacultural Engineering, 2001, Vol. 25, pp. 35-49) was done to evaluate the effectiveness of a zero-exchange recirculating system on the basis of water quality parameters. In terms of the denitrifying column, three different substrates were used. The results of this project showed that by using this design, most of the checked water quality parameters stayed within acceptable parameters with the exception of Nitrate. While this study showed that implementation of such a system is possible, improvements are still needed. Additionally the system setup employed expensive methods such as physical oxygen removal of oxygen via gaseous N₂, and then reoxygenation. Furthermore, no attention was paid to the possibility of methanol/ethanol concentration buildup which can be toxic.

A different approach towards the same problem was attempted by Shnel et al., (Design and performance of a zero-discharge tilapia recirculating system, Aquacultural Engineering, 2002, Vol. 26, pp. 191-203). Solids and backwash water, captured by the physical filter were diverted to a sedimentation basin. The denitrification process reduced the Nitrate content of the basin water, which was thereafter pumped back into the rearing tanks. This process was unsuccessful as a relatively high Nitrate concentration was quickly reached whereupon it stabilized.

An additional attempt to curb the increase of Nitrate was made by Suzuki et al., (Performance of a closed recirculating system with foam separation, nitrification, and denitrification units for intensive culture of eels: towards zero emission, Aquacultural Engineering, 2003, Vol. 29, pp. 165-182), wherein methanol, which served as the carbon source, was pumped into the denitrifying biofilter. The results of this study showed that this type of denitrification system has a high potential. Incorporating this type of filter and similar carbon sources could be effective in a zero-discharge recirculating system. The disadvantages of this system are mostly related to the extremely large size of the denitrification unit, and the lack of a deoxygenating method. For this system to be implemented into large scale use, initial capital investment might in fact be too high for the system to be economically feasible.

Though the results seem positive (Suzuki et al., 2003), a question still remains with the possible adverse effects of the addition of methanol, ethanol or glucose into marine culture systems. In order to cope with this problem, an additional carbon source, one that is not water soluble should be used. Soares et al., (Denitrification of groundwater: pilot-plant testing of cotton-packed bioreactor and post-microfiltration, Water Science and Technology, 2000, Vol. 42, pp. 353-359) showed that using cotton wool as a carbon source can also be effective in coping with Nitrate. Cellulose is the most abundant renewable resource in the world and constitutes a high proportion of both agricultural and domestic wastes. Using this design, Soares et al (2000) showed that achieving almost total denitrification is indeed possible without using soluble carbon sources. The downside of this study was that the size of the reactor was considerably large, and frequent clogging problems occurred due to the compaction of the cotton bed.

A nitrogen treating method and system for a nitrogen compound is described in U.S. Pat. No. 6,984,326, which attempts to reduce the size and cost of the treatment apparatus by a treatment process based on an electrochemical technique, wherein a cathode reaction region and an anode reaction region are defined by a cation exchange membrane interposed between a cathode and an anode.

A system for the treatment of wastewater is described U.S. Pat. No. 6,979,398, said system includes a conventional septic tank and two sanitization modules connected in series and automatically controlled by a controller, wherein the first sanitization module includes a cylindrical container and a filtering pouch, and wherein said cylindrical container includes small polymer balls used as a non-clogging media to attract the bacteria injected in the wastewater.

Japanese Patent No. 6320182 describes denitrification means for removing nitrogen from water wherein a number of contact filter media consisting of the nonwoven fabric coated with an insoluble pyridinium type resin are attached to a water-permeable container at intervals, said contact filter media are obtained by forming a string or paper strip on a porous nonwoven fabric consisting of fibers such as rayon, cotton, polyethylene, polypropylene, etc., having its surface coated with an insoluble pyridinium type resin having halogenated pyridinium group in the molecule.

The methods described above have not yet provided satisfactory solutions to the currently available biological water treatment methods. Therefore there is a need for suitable biological treatment systems and methods that overcomes the above mentioned problems.

It is therefore an object of the present invention to provide a system and method for efficiently removing nitrate and nitrite compounds in water treatment processes which requires significantly reduced vessel sizes and which allow reducing costs.

It is another object of the present invention to provide an apparatus and method for removing nitrate and nitrite compounds in water treatment processes which do not release organic residuals from the solid carbon source.

It is a further object of the present invention to provide an apparatus and method for removing nitrate and nitrite compounds in water treatment processes wherein denitrification inhibition due to dissolved oxygen is eliminated

It is yet another object of the present invention to provide an apparatus and method for removing nitrate and nitrite compounds in water treatment processes wherein the consumption of the carbon source is substantially reduced.

It is yet a further object of the present invention to provide a simple to maintain apparatus for removing nitrate and nitrite compounds in water treatment processes, wherein the biofilter media may be easily replaced.

It is yet another object of the present invention to provide a simple to construct and maintain apparatus for removing nitrate and nitrite compounds in water treatment processes, wherein the biofilter system may be easily enlarged by additional modules to cope with increasing flow rates.

It is yet another object of the present invention to provide a simple to maintain apparatus for removing oxygen using a degassing unit prior to the denitrification apparatus thus significantly reducing its size.

It is yet another object of the present invention to provide a simple to maintain apparatus for removing excess CO₂ from the aquaculture system through a degassing unit.

Other objects and advantages of the invention will become apparent as the description proceeds.

### SUMMARY OF THE INVENTION

The present invention generally relates to the treatment of nitrate rich water, particularly aquaculture pond water. The present invention provides a two-stage treatment process, wherein in the first stage a degassing chamber is used to remove dissolved oxygen from a stream of water flowing out of the aquaculture system, and in the second stage the stream of water obtained from said degassing chamber is flown into a denitrifying biofilter comprising a biofilter media which functions as a biological growth media and as a carbon source, wherein said denitrifying biofilter is capable of biologically reducing both nitrate and nitrite compounds into nitrogen gas.

The inventors of the present invention discovered that denitrification of water can be carried out efficiently utilizing relatively small (e.g., 45 liter biofilter for a 13 m³ aquaculture pond) treatment vessels, while minimizing release of organic residuals, preventing inhibition of denitrification, and simplifying maintenance and reducing costs.

In one aspect the present invention is directed to a denitrification apparatus comprising a degassing chamber adapted to remove dissolved oxygen from a stream of water flown thereinto, and an anoxic biofiltering means capable of carrying out denitrification of a stream of water received from said degassing chamber.

The degassing chamber may be implemented by a relatively small (e.g., approximately 5 liters) tank having a water inlet provided in the upper portion of said tank and a water outlet in the lower portion of said tank, preferably in its base, wherein said water inlet is connected to a spray nozzle installed in said tank near said water inlet, and wherein a degassing apparatus such as a vacuum pump (e.g., venturi vacuum pump) connected to an upper portion of said tank, preferably to its ceiling, is used for applying negative pressure conditions (e.g., 0.1-0.3 bars) thereinside.

The anoxic biofiltering means may be implemented by an elongated vessel comprising a water inlet and a water outlet provided in opposing sides thereof such that water streamed therethrough is flown along the length of said vessel, one or more biofilter medias disposed along the length of said vessel covering cross-sectional sections thereof such that water flown thereinside is forced to pass through said biofilter medias, and a plurality of spacer elements filling sections of said vessel. The biofilter medias preferably comprise materials (e.g., cotton) capable of functioning as growth media and as a Carbon source. The spacer elements are preferably small (e.g., having a diameter of about 5-8 mm) porous balls or beads.

A water pump may be used for supplying the stream of water to the degassing chamber.

In another aspect the present invention is directed to a method for denitrifying water, the method comprising: providing a stream of water, removing dissolved oxygen from said stream of water and thereafter filtering said stream of water by means of one or more biofilter medias capable of functioning as growth media and as a Carbon source. Advantageously, the filtering is carried out in an elongated vessel having the one or more biofilter medias installed along its length, wherein the water is flown along the length of said elongated vessel. A uniform water stream may be obtained in the elongated vessel by means of a plurality of spacer elements filling portions of said elongated vessel.

In yet another aspect the present invention is directed to a water treatment system comprising: a source of water, a degassing chamber adapted to receive a stream of water from said water source and remove dissolved oxygen therefrom, an anoxic biofiltering means adapted to denitrify a stream of water received from said degassing chamber by means of a biofilter media capable of functioning as a biological growth media and as a carbon source, an aerobic biofiltering means adapted to receive water stream from said water source and from said anoxic biofilter and to provide a nitrified stream (ammonia-free filtrate—following biological nitrification) to a water filtering means connected thereto. The water filtering means is preferably a type of particle sand filter aimed at purifying the water from suspended and colloid residuals for producing clear water. Advantageously, the anoxic biofiltering means is implemented by an elongated vessel one or more of the biofilter media disposed along its length and a plurality of spacers filling sections of said elongated vessel.

The water treatment system of the invention may be further used for removing excess CO₂ from the aquaculture system.

### BRIEF DESCRIPTION OF THE DRAWINGS

The present invention is illustrated by way of example in the accompanying drawings, in which similar references consistently indicate similar elements and in which:

FIG. 1 is a block diagram schematically illustrating a water treatment system according to a preferred embodiment of the invention;

FIG. 2 schematically illustrates a possible embodiment of the degassing chamber;

FIG. 3A schematically illustrates a preferred embodiment of the denitrifying biofilter;

FIG. 3B is a perspective view of a preferred embodiment of the biofilter media;

FIGS. 4A and 4B are graphs showing nitrate concentrations obtained with two experimental implementations of the invention; and

FIG. 5 is a graph showing the results obtained with an implementation of the invention without the degassing chamber.

It should be noted that the embodiments exemplified in the Figs. are not intended to be in scale and are in diagram form to facilitate ease of understanding and description.

### DETAILED DESCRIPTION OF PREFERRED EMBODIMENTS

The present invention relates to a Nitrogen treatment system and method for treating water containing inorganic Nitrogen (Nitrate and nitrite), such as nitrate rich aquaculture water. The Nitrogen treatment of the present invention incorporates a two-stage approach in carrying out the denitrification process. In the first stage, dissolved oxygen is removed from the water by a degassing chamber, thereafter the water is flown from the degassing chamber into a denitrifying biofilter, wherein the biofilter media (e.g., cotton-wool), is used as a biological growth media and as a carbon source, which serves as a primary electron donor.

FIG. 1 is a block diagram schematically illustrating a water treatment system 10 according to a preferred embodiment of the invention. Water treatment system 10 circulates the water in pond 11 through three treatment subsystems: i) an anoxic denitrification subsystem 10a; ii) an aerobic nitrification filtration subsystem 12; and iii) a physical filtration system 13. The three sub-systems may be operated independently. Alternatively and preferably, the water stream 17s obtained from anoxic denitrification subsystem 10a is fed into aerobic nitrification filtration subsystem 12. In a preferred embodiment of the invention, aerobic nitrification filtration subsystem 12 receives two water feeds: i) a water stream 11s provided directly from pond 11; and ii) water stream 17s obtained from aerobic nitrification filtration subsystem 12. This flow arrangement enables complete removal of nitrites (which is a more toxic substance of the two, nitrate and nitrite) by a two fold action: denitrification (reduction of nitrite into nitrogen gas) in the anoxic biofilter 17 provided in anoxic denitrification subsystem 10a; and nitrification (oxidation of nitrite to nitrate) in aerobic nitrification filtration subsystem (aerobic biofilter) 12.

Anoxic denitrification subsystem 10a comprises a vacuum degassing chamber 16, which receives a stream of pond water 11p from pond 11, and an anoxic biofilter 17, which receives a stream of water obtained from vacuum degassing chamber 16 and outputs a water stream 17s supplied to aerobic nitrification filtration subsystem 1b.

Aerobic nitrification filtration subsystem 12 comprises an aerobic trickling biofilter which provides a stream of water (the obtained filtrate) to physical filtration unit 13, said aerobic nitrification filtration subsystem 12 receives a stream of pond water 11s (containing ammonia) and outputs a stream of water 12s which is supplied to said physical filtration unit 13. A water stream 13t provided by filtration unit 13 is reintroduced into pond 11, and a portion of this stream 13s is supplied to protein fractionator 14, which is used for removing organic matter and fine solids therefrom.

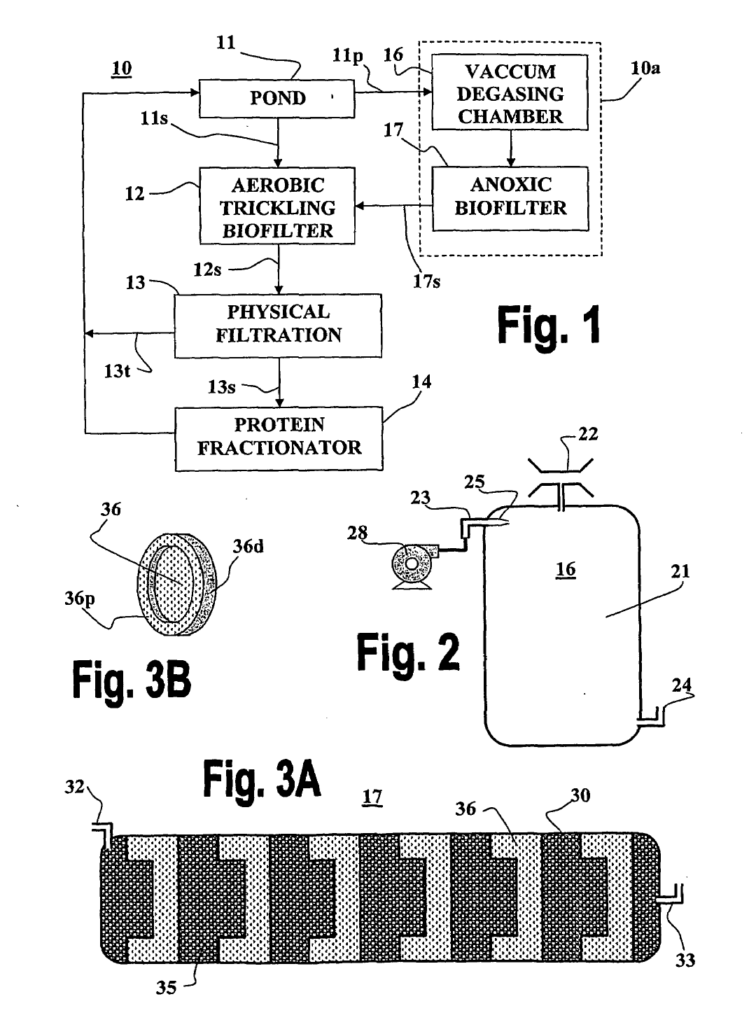

With reference to FIG. 2, vacuum degassing chamber 16 comprises a water tank 21 having a water inlet 23 preferably provided in an upper portion of said water tank 21, a water outlet 24 preferably provided in a lower portion of said water tank 21, and vacuum pump 22 provided in an upper portion of said water tank 21, preferably in its ceiling. A water pump 28 may be used for streaming water from pond 11 into water tank 21, via water inlet 23. Said water inlet 23 is connected to a spray nozzle 25 assembled inside water tank 21. In this way the water stream (11p) supplied by water pump 28 is sprinkled inside water tank 21 via spray nozzle 25 such that dissolved gaseous O₂ is effectively stripped therefrom by means of vacuum pump 22. Additionally, degassing chamber 16 may be used to resolve further problems associated with intensive aquaculture systems wherein there is accumulation of carbon dioxide gas in the system water. Namely, the CO₂ accumulated in the water can be stripped simultaneously with the stripped oxygen and thus reduce quantities of chemicals needed for pH control.

Pond 11 is typically a man made water reservoir capable of holding water volumes needed for growth and reproduction of a variety of aquaculture products. The water in pond 11 may comprise mixtures of freshwater and seawater (up to 40 g/l) to enable growing of marine and freshwater organisms (e.g fish, crustacean invertebrates or algae). The shapes of the tanks and the drainage systems should be specifically adapted to each production scheme.

Water tank 21 may be any type of metallic or plastic vessel capable of maintaining the needed pressure conditions needed for the oxygen stripping to take place. In a specific embodiment of the invention, water tank 21 employed is a relatively simple system designed to occupy a volume of about 10 liters (e.g., for handling a 13 m³ aquaculture pond), operated with a very low vacuum of about 1 psi. With such operational parameters oxygen concentrations in the treated water may be reduced from saturation to zero.

A special experiment was conducted to assess the efficiency of CO₂ stripping by the experimental system using pond water bubbled with CO₂ to an average CO₂ concentration of 1,200 mg/L. In this experiment it was found that 50% of the CO₂ could be stripped under the mild vacuum conditions applied.

Vacuum pump 22 may be implemented by any suitable pressure pump capable of applying negative pressure conditions in water tank 21. In a specific embodiment of the invention said pressure conditions is in the range of 100 to 500 mbar, preferably about 100 mbar if oxygen stripping only is required. Preferably, vacuum pump 22 is a type of venturi vacuum pump, such as, but not limited to, JD-100M-STAA4 manufactured by Vaccon (USA). In the specific embodiment of the invention water pump 28 may be implemented by a small pump capable of providing flow rates in the range of 10 to 30 liters/h, preferably about 20 liters/h.

Degassing chamber 16 may be placed above anoxic biofilter 17.

With reference to FIG. 3A, wherein a cross-longitudinal view of anoxic biofilter 17 is shown, which comprises an elongated vessel 30 having a water inlet 33 and a water outlet 32, said water inlet 33 and water outlet 32 are preferably provided in opposing sides of said elongated vessel 30 in order to obtain liquid flow along its length. Advantageously, water inlet 33 is centered in the side of elongated vessel 30 opposing the side wherein water outlet 32 is located. This configuration of anoxic biofilter 17 provides a side-flow regime thereby obtaining reduced hydraulic pressure on the biofilter media 36 provided in elongated vessel 30.

The biofilter media 36 located inside elongated vessel 30 should fit into cross sectional portions thereof such that the liquid stream passing thereinside is forced to pass through said biofilter media 36. The space between adjacent biofilter media 36 sections inside elongated vessel 30, and between said biofilter media 36 and the sides of elongated vessel 30, is filled with beads 35, which are used to increase the surface area of biofilter 17 and thereby provide a uniform liquid flow along the length of elongated vessel 30, and for providing support for biofilter media 36 disposed thereinside. This structure of anoxic biofilter 17 increases biofilter media 36 surface area despite compression, by preventing pressure drops and enabling simple replacement of the filtering media 36.

In a preferred embodiment of the invention elongated vessel 30 is a cylindrical elongated vessel and biofilter media 36 disposed thereinside, as illustrated in FIG. 3B, is shaped in a form of a disk 36d having a circumferential projection 36p at the boundaries of one side thereof. In this way water can continuously flow through elongated vessel 30 without occurrence of pressure drops and compaction of the biofilter media 36.

Elongated vessel 30 may be any type of metallic or plastic vessel. In a specific embodiment of the invention, elongated vessel 30 is a cylindrical vessel having a volume in the range of 30 to 80 liters, preferably about 50 liters, having a length generally in the range of 50 to 80 cm, preferably about 65 cm, and a radius generally in the range of 10 to 20 cm, preferably about 15 cm. In such specific embodiment the width of biofilter media (modules) 36 may be in the range of 10 to 20 cm, and the number of modules disposed along elongated vessel 30 is preferably in the range of 5 to 10.

Biofilter media 36 preferably comprise materials that can serve as a solid carbon source, such as, but not limited to, raw cotton or straw, preferably cotton wool. Biofilter media 36 may be encased in a metallic/plastic net configured in a desirable shape, such as shown in FIG. 3B, said metallic/plastic may have aperture size in the range of 50 to 100 mm, preferably about 80 mm. In a preferred embodiment of the invention biofilter media 36 is made entirely from cotton wool, which serves dually as biological growth media and as carbon source for denitrification bacteria. Beads 35 are preferably small porous balls having a diameter generally in the range of 5 to 10 mm, preferably about 8 mm. Beads 35 may be made from plastic. Beads 35 serve as spacers, for reducing biofilter media 36 overall compressibility, and also serve to homogenize the liquid flow through elongated vessel 30.

In a specific embodiment of the invention the flow rate through anoxic biofilter 17 may generally be in the range of 10 to 30 liter/h, preferably about 20 liter/h. Anoxic biofilter 17 may be placed directly under the degassing chamber 16.

Aerobic trickling biofilter of aerobic nitrification filtration subsystem 12 may be any type of aerobic trickling biofilter as commonly used in the aquaculture industry. The physical filtration 13 is preferably carried out by means of a particulate sand filter, for example, Astral 750, manufactured by Astarlpool (Spain). Of course, other conventional filters may be equally employed for the same purpose. Protein fractionator 14 may be implemented by any suitable fractionator as commonly used in the aquaculture industry.

### Example

The following non-limiting example presents results obtained in an experimental setup of the present invention.

The anoxic biofilter (˜50 liter) was constructed from a PVC pipe that was filled with commercial cotton wool (such as commercially available in pharmacies), and plastic beads packed in the manner illustrated in FIG. 3A. Cotton wool served as the main carbon source for the denitrifying bacteria as well as its growth medium due to its low cost, availability, low water solubility, and due to the fact that it does not breakdown into other organic compounds. In this system, the beads served primarily as spacers, which help to reduce the overall compressibility of the cotton. This increased the active zone (zone which the denitrification takes place) and thereby increased overall effectiveness. The total amount of beads in the column was approximately 26 liter, and the total cotton wool content was about 1.1 kg. Upstream to the anoxic biofilter, a small (10 liter) plastic degassing chamber, which was placed above the cotton-wool-filled column, was used for physically stripping the water of dissolved gaseous O₂ by means of a Venturi vacuum tube (Vaccon JD-100M-STAA4), thereby eliminating the need for other degassing techniques such as the bubbling of Nitrogen gas. The influent pipe of the degassing chamber comprise a spray-like ending inside degassing chamber, containing a number of small holes; thereby increasing the surface-area to volume ratio of the water to be deoxygenated. Using this approach an effective and low maintenance system was produced which enabled effective denitrification.

The experimental set-up was situated in a greenhouse at the Ben-Gurion University of the Negev, Beer-Sheva, Israel. Beer-Sheva is located inland approximately 60 km from the nearest coastline. Two artificial shrimp ponds were located inside a dark room (6×12 m) that occupied half of the greenhouse. Water from the ponds was allowed to flow out of the dark room into separate water treatment facilities that occupied the other half of the greenhouse. Each water treatment facility included: an aerobic biofilter, a pump (UltraFlow, Pentair Pool Products, USA), a particulate sand filter (Astral 750, Astarlpool, Spain). The denitrifying biofiltration system and a foam fractionator (Fresh-Skim 200, Sander, Germany) were assembled in parallel to the main water flow. A small aquarium pump fed the water from the shrimp pond directly to the denitrifying biofiltration system, and the water stream obtained from its outlet was flown to the aerobic biofilter (FIG. 3A). The aerobic biofilter comprised a polyethylene container (˜100 liter) filled with plastic beads (Aridal Bio-Balls, 860 m² of surface area and 160 kg per cubic meter, Aridal, Israel). Each pond was filled with 13 m³ synthetic brackish water and was maintained at 29±1° C. Synthetic brackish water was prepared by raising the salinity of local tap water to 4 ppt (Atkinson and Bingman, 1997 (Atkinson, M. J., Bingman, C., 1997. Elemental composition of commercial seasalts. J. Aquaricult. Aquatic. Sci. 8, 39-43.) with synthetic sea salts (Red Sea Salt, Red Sea, Israel). Pond biomass density was approximately 590 g/m³, and dry feed constituted approximately 3.5% of total biomass a day.

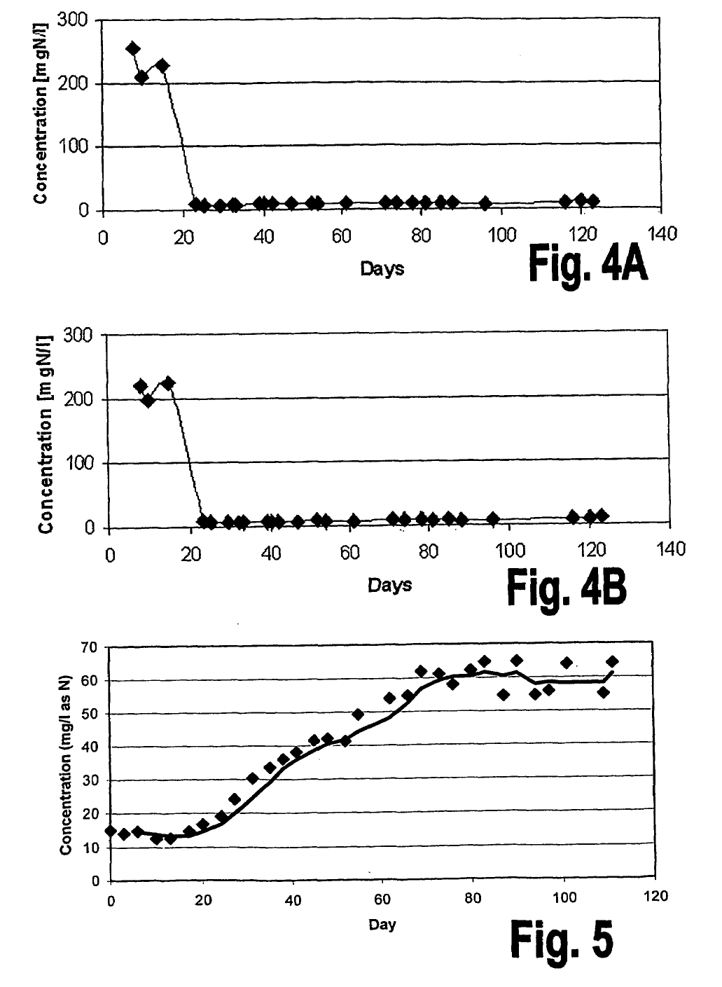

FIGS. 4A-4B show the results obtained with both systems after 115 days, wherein FIG. 4A shows the N-Nitrate concentrations in the first experimental system and FIG. 4B shows the N-Nitrate concentrations in the second experimental system. The results of both systems suggest that maintaining a low nitrate level in system water is possible. Starting Nitrate levels were very high and a sharp decline was evidenced after approximately 2 weeks. After the sharp decline, nitrate levels remained stable at approximately 6-7 mgN/l.

In comparison, a similar experiment was initially completed with the intent to understand the importance of the degassing pre-treatment phase. FIG. 5 shows the results of the preliminary system, without the degassing chamber. Starting N-Nitrate levels were low initial N-Nitrate concentrations. However due to a steady increase in N-Nitrate concentrations due to reduced biofilter efficiency, the system reached a final steady-state concentration of approximately 60 mg/l as N.

The following table lists various parameters of the experimental setup exemplified hereinabove.

| | System 1 | System 2 |
|---|---|---|
| Anoxic biofilter | 45 | 45 |
| volume (l) | | |
| System biomass concen- | 596.2 | 596.2 |
| tration (g/m3) | | |
| Flow rate (l/h) | ~20 | ~20 |
| Days operated | 115 | 115 |
| Total water volume passing | 55.2 | 55.2 |
| through anaerobic column (m3) | | |
| (grams cotton applied)/ | 0.859 | 0.796 |
| (grams Nitrate-N removed) | | |
| (grams cotton applied)/ | 19.56 | 19.56 |
| (m3 water treated) | | |

As was described and exemplified hereinabove, the present invention provides efficient nitrate removal scheme for water treatment processes, wherein the facilities used for carrying out the denitrification are of relatively small sizes and employs relatively inexpensive means. Among the many advantages of the invention, the following are particularly desirable in aquaculture systems:
1. No release of organic residuals from the solid carbon source (cotton).
2. No inhibition of denitrification due to the removal of feed water dissolved oxygen by the degassing device.
3. Reduced consumption of the carbon source due to more efficient denitrification (no aerobic consumption of cotton).
4. Physical filtration of the treated water and preservation of denitrification bacteria within the biofilter by the cotton-bead media.
5. Reduction of biofilter volume due to the increased process efficiency.
6. Simple maintenance (no need to dose a continuous liquid carbon source).
7. Easy replacement of biofilter media and of modular expansion.

It should be appreciated that the denitrification system of the invention is simple to construct and maintain and that this innovative biofilter system may be easily enlarged by the addition of bed modules to cope with increasing flow rates. In addition, the size of the denitrification system of the invention is significantly reduced, compared to systems of the prior art, due to the oxygen removal unit employed. Additional advantages of the invention are in its ability to remove excess CO₂ from the aquaculture system through the degassing unit in that it may prolong the time periods of using the same body of water (i.e., water saving) and prevents the release of contaminated water into the local sewage system.

It should be noted that the present invention may be employed in other applications involving anaerobic bio-filters for the treatment of water and wastewater.

All of the abovementioned parameters are given by way of example only, and may be changed in accordance with the differing requirements of the various embodiments of the present invention. Thus, the abovementioned parameters should not be construed as limiting the scope of the present invention in any way. In addition, it is to be appreciated that the different vessels, tanks, and other members, described hereinabove may be constructed in different shapes (e.g. having oval, square etc. form in plan view) and sizes differing from those exemplified in the preceding description.

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1. A denitrification apparatus comprising a degassing chamber adapted to remove dissolved oxygen from a stream of water flown thereinto, and anoxic biofiltering means capable of carrying out denitrification of a stream of water received from said degassing chamber.

2. The denitrification apparatus according to claim 1, wherein the degassing chamber also removes carbon dioxide.

3. The denitrification apparatus according to claim 1, wherein the degassing chamber comprises a water tank having a water inlet provided in an upper portion thereof and a water outlet provided in a lower portion thereof, and wherein said water inlet is connected to a spray nozzle installed in said tank, and wherein a vacuum pump connected to an upper portion of said tank, is used for applying negative pressure there inside.

4. The denitrification apparatus according to claim 1, wherein the anoxic biofiltering means comprises an elongated vessel comprising a water inlet and a water outlet provided in opposing sides thereof, such that water streamed therethrough is flown along a length of said vessel, and one or more biofilter medias disposed thereinside.

5. The denitrification apparatus according to claim 4, wherein, the one or more biofilter medias are disposed along the length of the elongated vessel covering cross-sectional sections thereof such, that water flown thereinside is forced to pass through said one or more biofilter medias.

6. The denitrification apparatus according to claim 5, further comprising a plurality of spacer elements filling sections of the elongated vessel.

7. The denitrification apparatus according to claim 6, wherein the one or more biofilter medias comprise materials capable of functioning as growth media and as a Carbon source.

8. The denitrification apparatus according to claim 7, wherein the one or more biofilter medias comprise cotton-wool.

9. The denitrification apparatus according to claim 6, wherein the spacer elements are small porous balls or beads.

10. The denitrification apparatus according to claim 1, further comprising a water pump for supplying the stream of water to the degassing chamber.

11. A method for denitrifying water, comprising: providing a stream of water, removing dissolved oxygen from said stream of water and thereafter filtering said stream of water by means of one or more biofilter medias capable of functioning as growth media and as a Carbon source for denitrifying bacteria.

12. The method according to claim 11, wherein the filtering is carried out in an elongated vessel having one or more biofilter medias installed along its length, and wherein the stream of water is flown along the length of said elongated vessel.

13. The method according to claim 12, wherein a uniform water stream is obtained in the elongated vessel by means of a plurality of spacer elements filling portions of said elongated vessel.

14. The method according to claim 13, wherein the plurality of spacer elements minimize pressure drops and prevent compaction and clogging of the biofilter media.

15. A water treatment system comprising: a source of water, a degassing chamber adapted to receive a stream of water from said water source and remove dissolved oxygen therefrom, an anoxic biofiltering means adapted to denitrify a stream of water received from said degassing chamber by means of a biofilter media capable of functioning as a biological growth media and as a carbon source, an aerobic biofiltering means adapted to nitrify water streams received from said water source and from said anoxic biofilter and provide a nitrified stream to a water filtering means connected thereto.

16. The water treatment system according to claim 15, wherein the water filtering means is a type of particle sand filter.

17. The water treatment system according to claims 15, wherein the anoxic biofiltering means comprises an elongated vessel having one or more of the biofilter media disposed along its length and a plurality of spacers filling sections of said elongated vessel.
